(19) United States
(12) Patent Application Publication
(10) Pub. No.: US 2024/0305556 A1
(43) Pub. Date: Sep. 12, 2024

(54) NETWORK CONTROLLER, NETWORK CONTROLL METHOD, AND NETWORK CONTROLL PROGRAM

(71) Applicant: NIPPON TELEGRAPH AND TELEPHONE CORPORATION, Tokyo (JP)

(72) Inventors: Takayuki NAKAMURA, Musashino-shi, Tokyo (JP); Mitsuo AMASAKA, Musashino-shi, Tokyo (JP); Takuya SATO, Musashino-shi, Tokyo (JP); Hideo TSUCHIYA, Musashino-shi, Tokyo (JP); Takamitsu NARUMI, Musashino-shi, Tokyo (JP)

(21) Appl. No.: 18/277,026

(22) PCT Filed: Feb. 16, 2021
(86) PCT No.: PCT/JP2021/005756

§ 371 Date: Aug. 11, 2023

(51) Int. Cl. H04L 45/125; H04L 45/00

(52) U.S. Cl. CPC H04L 45/125; H04L 45/22

(57) ABSTRACT

A detour route calculation unit of an NW controller specifies a slice capable of changing a route among slices stored in an inter-SLG path via a link to be detoured based on a network requirement set for each slice. Next, the detour route calculation unit calculates a route for detouring the link to be detour, from among routes between SLGs storing the specified slice. Then, the detour route calculation unit selects a slice having the largest bandwidth usage from among the specified slices, the bandwidth usage of the slice being equal to or less than the surplus bandwidth of the detour route of the slice. Thereafter, the detour route calculation unit newly sets an inter-SLG path via the detour route, and changes the setting of the SLG so that the selected slice passes through the newly set path.

### TECHNICAL FIELD

The present invention relates to a network controller, a network control method, and a network control program.

### BACKGROUND ART

Conventionally, there is a network slicing technique which is a technique for simultaneously constructing a plurality of virtual networks having different requirements, called network slices (slices) on a common physical substrate. In the network slicing technology, the infrastructure of shared physical equipment is managed as virtually divisible resources, and such resources are freely combined to build a required virtual network. According to the network slicing technique, a network can be quickly and flexibly provided for various network requirements.

As a network configuration for realizing the above-mentioned network slicing, there has been proposed a configuration using a slice gateway (SLG) which is a gateway of a network end point for performing packet processing specialized in a slice and an inter-SLG path for connecting the SLGs. Using a conventional technique capable of explicitly designating a route represented by Segment Routing or MPLS-TE as an inter-SLG path in this configuration, the route is detoured so as not to pass through a specific link in the network, and bandwidth pressures on the link can be prevented.

### CITATION LIST

### Non Patent Literature

[NPL 1] Nakamura et al., “Study of D-Plane architecture and implementation method of E2E slice,” IEICE Technical Report, vol. 120, No. 4, NS2020-6, pp. 51-56, April 2020.
[NPL 2] “Segment Routing Architecture,” [retrieved on Feb. 1, 2021], the Internet <URL: https://tools.ietf.org/html/rfc8402>
[NPL 3] Multi Protocol Label Switching (MPLS) Traffic Engineering (TE) [retrieved on Feb. 1, 2021], the Internet <URL: https://tools.ietf.org/html/rfc3812>

### SUMMARY OF INVENTION

### Technical Problem

However, in the prior art, for example, even if the inter-SLG path is detour so that the inter-SLG path does not pass through a link in which bandwidth pressure occurs, there is a possibility that bandwidth pressure occurs in the link on the detour route side. In addition, in a case where slices having different network requirements are superimposed on the same inter-SLG path, there is the in that route detouring in consideration of the network requirements for each slice cannot be performed.

The present invention solves the above-mentioned problem, takes into consideration network requirements for each slice, the object is detour a route of the inter-SLG path so as to prevent pressure of a bandwidth on the detour route side.

### Solution to Problem

In order to solve the above problem, the present invention includes a specification unit that specifies a slice capable of changing a route among slices stored in a path between slice gateways (SLGs) via a link to be detoured around based on network requirements set for each slice, a route calculation unit that calculates a detour route for detouring the link to be detoured around from among routes between the SLGs accommodating the specified slice, a selection unit that selects a slice having the largest bandwidth usage from slices whose bandwidth usage of the slice is equal to or less than a surplus bandwidth of a detour route of the slice among the specified slices, and a path setting unit that newly sets an inter-SLG path passing through the detour route, and performs route detour processing for changing the setting of the SLG so that the selected slice passes through the set inter-SLG path.

### Advantageous Effects of Invention

According to the present invention, route detouring of the inter-SLG path can be performed in consideration of network requirements for each slice and so as to prevent pressure of a bandwidth on the detour route side.

### BRIEF DESCRIPTION OF DRAWINGS

FIG. 1 is a diagram illustrating an example of a network configuration.

FIG. 2 is a diagram for illustrating an overview of a NW controller.

FIG. 3 is a diagram illustrating a configuration example of a system including the NW controller.

FIG. 4 is a diagram illustrating examples of NW topology information, a bandwidth usage of a link collected by an NW information collection unit, and an amount of delay in payment.

FIG. 5 is a diagram illustrating an example of topology information of each inter-SLG path.

FIG. 6 is a diagram illustrating examples of NW requirements of each slice, SLG of a storage destination of each slice, and an inter-SLG path of a storage destination, and a bandwidth usage of each slice collected by the NW information collection unit.

FIG. 7 is a diagram illustrating a configuration example of a detour route calculation unit in FIG. 3.

FIG. 8 is a diagram illustrating an example of a processing procedure of the NW controller

FIG. 9 is a diagram illustrating an example of a network configuration.

FIG. 10 is a diagram illustrating a configuration example of a computer that executes a NW control program.

### DESCRIPTION OF EMBODIMENTS

Hereinafter, a mode for carrying out the present invention (an embodiment) will be described with reference to the drawings. The present invention is not limited to the embodiments described below.

### [Network Configuration]

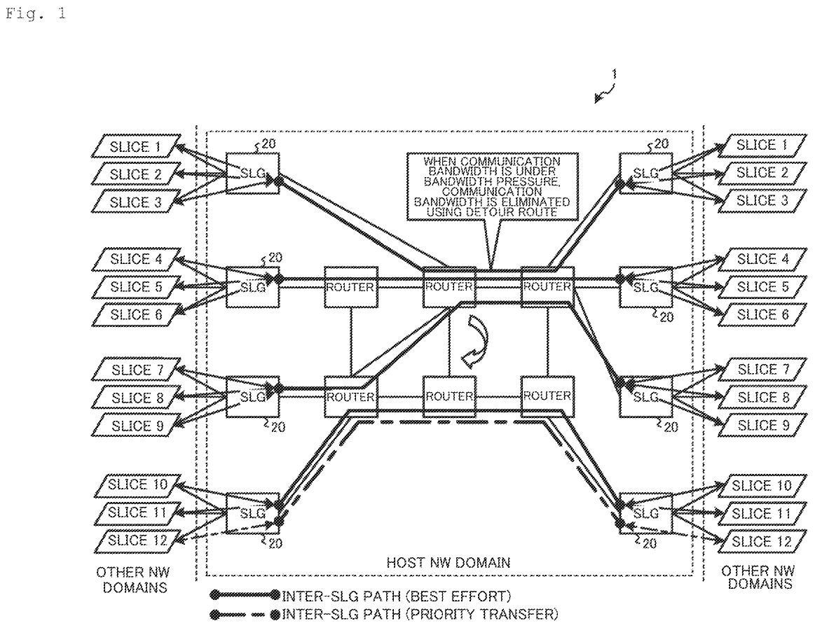

First, a network configuration as a premise will be described with reference to FIG. 1. The network is provided with an SLG 20 for performing transfer control corresponding to each slice at an end point of a network (NW) domain, for example. In addition, a router (transfer device) is arranged between the SLGs 20. A path (inter-SLG path) via a router is set between SLGs, and traffic of each slice is transferred via the inter-SLG path.

Although not illustrated here, in the slice, network requirements such as a communication route, a communication bandwidth (bandwidth), and delay time are set. The inter-SLG path is shared between slices having similar network requirements.

In order to perform data transfer according to network requirements for each slice (for example, delay time is set within a predetermined time), the inter-SLG path is set for each transfer priority (QOS class). In FIG. 1, for the sake of simplicity, only one inter-SLG path is used for priority transfer, and the other inter-SLG paths are used for transfer in the best effort.

Although the inter-SLG path normally takes the shortest route, for example, in a case where the bandwidth pressure or the like occurs in a part of links, the bandwidth pressures on the link is eliminated using the detour route.

### Outline

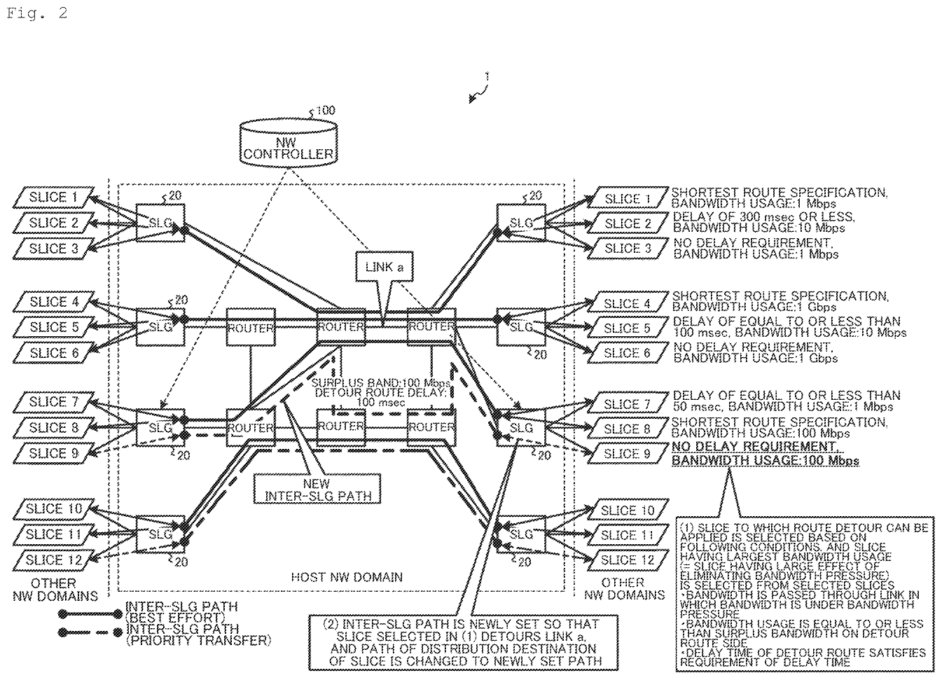

First, the outline of a NW controller 100 of the present embodiment will be described with FIG. 2. The NW controller 100 is a device for controlling a SLG 20 and a router in the network. For example, when bandwidth pressure occurs in any link in the network, the NW controller 100 performs route detouring of the slice path in the following manner.

Here, consider a case where bandwidth pressure occurs in a link a illustrated in FIG. 2. In this case, the NW controller 100 selects a slice to which the route detour can be applied based on the following conditions, and selects a slice having the largest bandwidth usage (=a slice having a large effect of eliminating the bandwidth pressure) from among the selected slices ((1)).
The slice is routed over a link that is under bandwidth pressure.
The bandwidth usage of the slice is equal to or less than the surplus bandwidth on the detour route side.
The delay time of the detour route satisfies the requirement of the delay time of the slice.

For example, it is assumed that the detour route is a route indicated by a broken line in FIG. 1, the surplus bandwidth in the route is 100 Mbps, and the delay time is 100 msec. In this case, the NW controller 100 selects a slice 9 (no delay requirement, bandwidth usage: 100 Mbps) as a slice satisfying each of the above conditions.

Next, the NW controller 100 newly sets an inter-SLG path so that the slice selected in (1) performs detouring of the link a, and changes the path of the distribution destination of the slice to the newly set path ((2)).

For example, the NW controller 100 newly sets an inter-SLG path indicated by a broken line so that the slice 9 selected in (1) detours the link a, and changes the path of the distribution destination of the slice 9 to the newly set path. Thus, the NW controller 100 can perform detouring of the inter-SLG path in consideration of NW requirements for each slice. Further, the NW controller 100 can prevent pressure of a bandwidth on the detour route side.

### Configuration Example

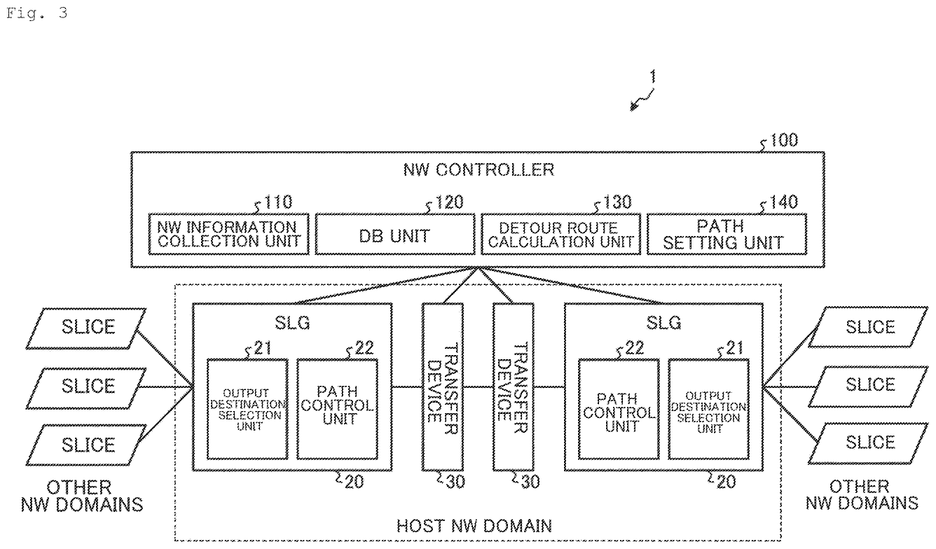

Next, a configuration example of a system including the NW controller 100 will be described with reference to FIG. 3. A system 1 includes the SLG 20, a transfer device 30, and the NW controller 100. The SLG 20, the transfer device 30, and the NW controller 100 are communicatively connected via a network.

The SLG 20 performs transfer control satisfying NW requirements of each slice at an end point of its own NW domain. The SLG 20 includes an output destination selection unit 21 and a path control unit 22.

The output destination selection unit 21 selects an output destination of an input packet. For example, when receiving input of a packet from another NW domains, the output destination selection unit identifies a slice to which the packet belongs. Then, the output destination selection unit 21 determines an inter-SLG path satisfying the NW requirement of the slice to which the packet belongs, and transfers the processing to the path control unit 22.

In addition, when receiving the input of the packet from the inter-SLG path, the output destination selection unit 21 identifies the slice to which the packet belongs in the same manner as described above. Then, the output destination selection unit 21 outputs the packet to a slice to which the packet belongs.

The path control unit 22 adds a header of the inter-SLG path selected by the output destination selection unit 21 to the packet delivered from the output destination selection unit 21, and outputs the packet to the transfer device 30. In addition, when receiving the input of the packet from the transfer device 30, the path control unit 22 eliminates the header of the inter-SLG path added to the packet and transfers the processing to the output destination selection unit 21.

The transfer device 30 transfers the packet based on the header information of the inter-SLG path added to each packet. The protocol used for the inter-SLG path is, for example, segment routing, MPLS-TE, or the like which can pass through a specific route.

The NW controller 100 controls the SLG 20 and the transfer device 30 in the network. Further, the NW controller 100 collects network information such as a bandwidth and a delay time of each link in the network.

The NW controller 100 includes an NW information collection unit 110, a DB unit 120, a detour route calculation unit 130, and a path setting unit 140.

The NW information collection unit 110 collects information on the bandwidth usage and delay time (transfer delay amount) of each link, the bandwidth usage of each slice, and the like, and stores them in the DB unit 120. For example, the NW information collection unit 110 calculates a value of each information at every predetermined time by the following method, and updates the value of each information in the DB unit 120 by the calculated value.

For example, the NW information collection unit 110 calculates a bandwidth usage of each link using a bit rate of an interface of the SLG 20 and the transfer device 30.

Further, the NW information collection unit 110 calculates the transfer delay amount of each link from the Round-Trip Time (RTT) of ICMP Echo Request/Reply between adjacent devices (for example, between SLG and transfer device, between transfer device and transfer device).

The NW information collection unit 110 calculates the bandwidth usage of each slice using a bit rate of an interface between the SLG 20 and each slice.

The DB unit 120 stores various information that the detour route calculation unit 130 and the path setting unit 140 refer to. The DB unit 120 stores, for example, NW topology information, topology information of paths between SLGs, NW requirements of each slice, the SLGs 20 accommodating each slice, the inter-SLG path of storage destinations, and the like. The DB unit 120 stores the bandwidth usage and the transfer delay amount of each link, the bandwidth usage of each slice, and the like collected by the NW information collection unit 110.

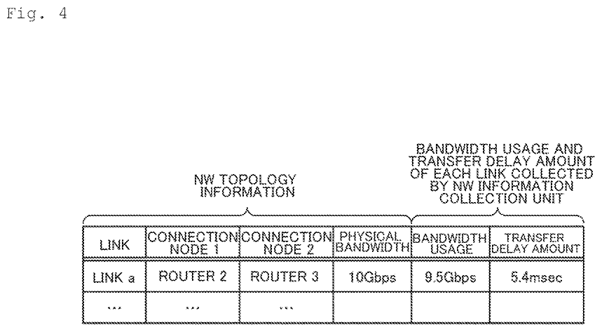

The information stored in the DB section 120 will be described below. The NW topology information is information indicating nodes such as the SLG 20 and the transfer device 30, and a physical bandwidth of a link connecting the nodes, etc. As illustrated in FIG. 4, the NW topology information includes, for example, a node (connection node) connected by the link, a physical bandwidth of the link, and the like for each link. As illustrated in FIG. 4, the NW topology information may be stored in the DB unit 120 in association with the information on the bandwidth usage for each link and the transfer delay amount collected by the NW information collection unit 110.

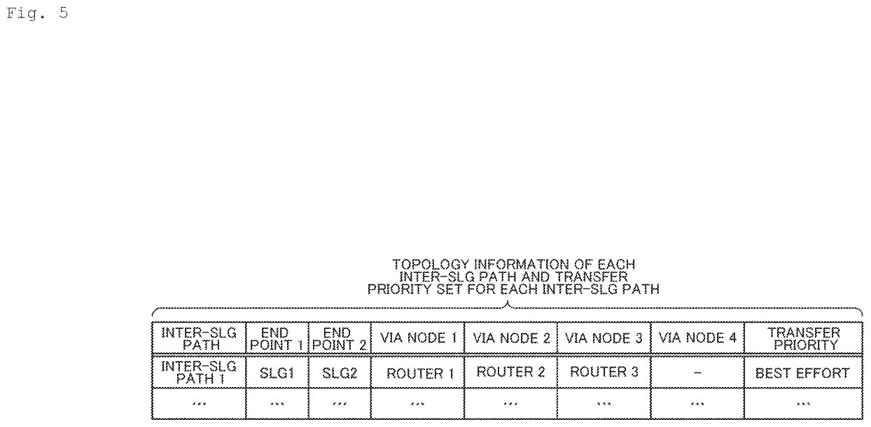

As illustrated in FIG. 5, the topology information of each inter-SLG path includes, for example, an SLG 20 which is an end point of the inter-SLG path for each inter-SLG path, and a router or a link passing between the SLG 20 to be the end point. The topology information of each inter-SLG path may include a transfer priority set for the inter-SLG path, for example, as illustrated in FIG. 5.

In addition, the NW requirements of each slice are information indicating, for example, delay requirements, route requirements, and the like of each slice. The delay requirement is, for example, information indicating a delay time allowed for the slice. The route requirement is information indicating, for example, the requirement of the route taken by the slice (for example, only the shortest route is used).

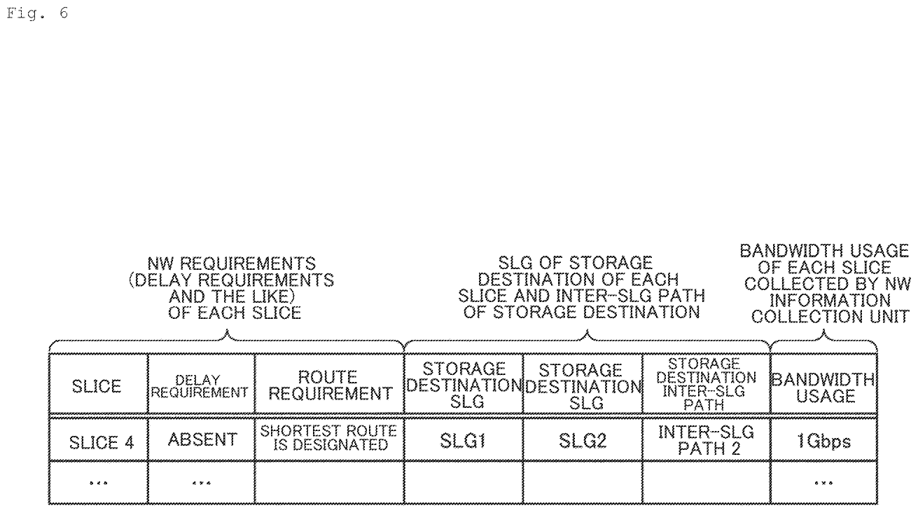

As illustrated in FIG. 6, for example, the NW requirements of each slice may be stored in the DB unit 120 in association with the SLG 20 of the storage destination and the inter-SLG path of the storage destination of each slice and the bandwidth usage of each slice collected by the NW information collection unit 110.

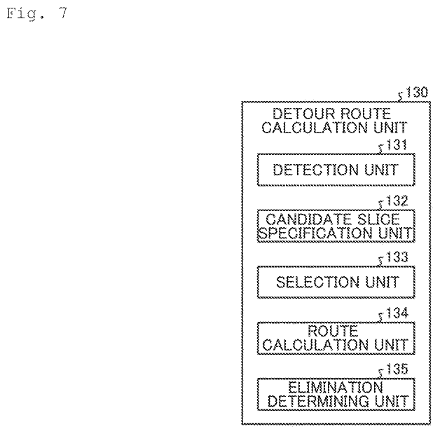

The description will now return to FIG. 3. The detour route calculation unit 130 performs calculation of a detour route and selection of a slice to which the detour route is applied using each information stored in the DB unit 120. As illustrated in FIG. 7, for example, the detour route calculation unit 130 includes a detection unit 131, a candidate slice specification unit 132, a selection unit 133, a route calculation unit 134, and an elimination determining unit 135.

The detection unit 131 detects a link to be detour. The detection unit 131 detects, for example, a link whose bandwidth use rate is equal to or more than a predetermined threshold (a link in which the bandwidth pressure occurs) as a link to be detoured based on information on the bandwidth usage of each link collected by the NW information collection unit 110 (refer to FIG. 4).

The candidate slice specification unit 132 specifies a slice capable of changing a route as a candidate slice among slices stored in the inter-SLG path via a link to be detour.

For example, the candidate slice specification unit 132 specifies a slice stored in the inter-SLG path passing through the link for the link to be detoured based on topology information (refer to FIG. 5) of each inter-SLG path and information (refer to FIG. 6) indicating the inter-SLG path of each slice storage destination. Then, the candidate slice specification unit 132 specifies a slice capable of changing a route as a candidate slice from among the specified slices based on the NW requirements (refer to FIG. 6) of the specified slice.

For example, the candidate slice specification unit 132 specifies the use of the shortest route as NW requirements among the specified slices, a slice other than a slice in which a delay time set to a delay requirement of the NW requirement is short (for example, 10 msec or less) is specified as a candidate slice.

The selection unit 133 selects a slice to be a target of route detour. For example, the selection unit 133 selects, among the candidate slices specified by the candidate slice specification unit 132, a bandwidth usage by the slice is equal to or less than a surplus bandwidth on the detour route side, and selects a slice in which the delay time of the detour route satisfies the delay requirement of the slice. Then, the selection unit 133 selects a slice having the largest bandwidth usage among the selected slices. Details of the selection unit 133 will be described later.

The route calculation unit 134 calculates a route which does not pass through a link in which bandwidth pressure occurs and has the largest surplus bandwidth from among routes between SLGs storing the candidate slice specified by the candidate slice specification unit 132 as a detour route of the candidate slice. In addition, the route calculation unit 134 calculates the minimum surplus bandwidth and delay time of the calculated detour route. The details of the route calculation unit 134 will be described later.

The elimination determining unit 135 determines whether to eliminate the route detour of the slice after the route detour of the slice. For example, the elimination determining unit 135 monitors a bandwidth usage of the slice and a bandwidth usage of a link through which the slice has passed before the route detour processing after the route detour of the slice. In a case where a total value of the bandwidth usage of the slice and the bandwidth usage of a link through which the slice has passed before the route detour processing becomes equal to or less than a bandwidth allocated to the link, it is determined by the elimination determining unit 135 that the route detour of the slice is eliminated.

The path setting unit 140 sets the inter-SLG path passing through the detour route calculated by the route calculation unit 134. Then, the path setting unit 140 changes the setting of the SLG so that the slice selected by the selection unit 133 passes through the set path (performs the route detour processing).

For example, the path setting unit 140 adds setting of the inter-SLG path to the path control unit 22 of the SLG 20 which is both ends of the inter-SLG path passing through the detour route. The path setting unit 140 also adds setting to the transfer device 30 on the detour route as needed. Further, the path setting unit 140 changes the distribution setting of the output destination selection unit 21 in the SLG 20 storing the detour target slice to an inter-SLG path passing through the detour route.

Further, the path setting unit 140 performs elimination of the route detour of the slice. For example, in a case where it is determined by the elimination determining unit 135 that the route detour of the slice is released, the path setting unit 140 changes inter-SLG path of the storage destination of the route detoured slices to the route before the detour based on the determination. Then, the path setting unit 140 eliminates the inter-SLG path for detour.

For example, the path setting unit 140 eliminates the setting of the inter-SLG path passing through the detour route to the path control unit 22 of the SLG 20 which is both ends of the inter-SLG path passing through the detour route. In addition, the path setting unit 140 changes the distribution setting of the detour target slice in the output destination selection unit 21 to the state before the route detour.

### Example of Processing Procedure

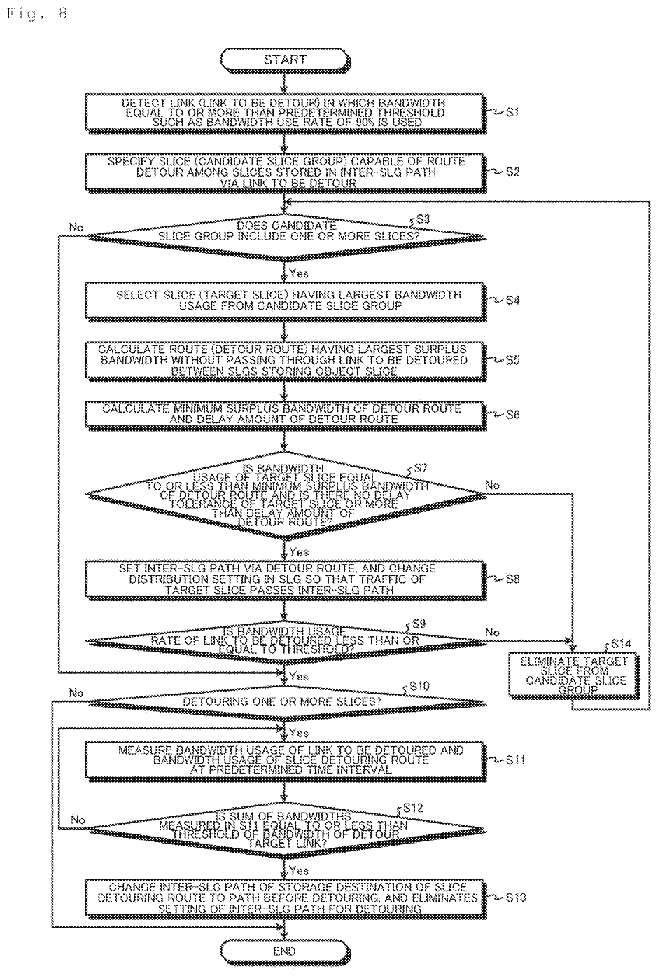

Next, an example of the processing procedure of the NW controller 100 will be described with reference to FIG. 8. For example, the detection unit 131 of the NW controller 100 detects a link (detour target link) in which a bandwidth equal to or more than a predetermined threshold is used (S1). For example, the detection unit 131 detects a link having a bandwidth usage rate of 90% or more.

After S1, the candidate slice specification unit 132 specifies a slice (candidate slice group) capable of route detour among slices stored in the inter-SLG path via the detour target link (S2). For example, the candidate slice specification unit 132 specifies the use of the shortest route as the NW requirement among slices stored in the inter-SLG path via the detour target link, and specifies the slice other than the slice (for example, 10 msec or less) in which the delay time set in the delay requirement is short, as a candidate slice group.

After S2, if one or more slices are included in the candidate slice group specified in S2 (Yes in S3), the selection unit 133 selects a slice (target slice) having the largest bandwidth usage from the candidate slice group (S4).

For example, the selection unit 133 selects a slice having the largest bandwidth usage as a target slice among the candidate slice groups based on the bandwidth usage (see FIG. 6) of each slice collected by the NW information collection unit 110.

After S2, if one or more slices are not included in the candidate slice group specified in S2 (No in S3), the processing proceeds to S10.

After S4, the route calculation unit 134 calculates a route (detour route) having the largest surplus bandwidth without passing through the detour target link between SLGs storing the target slice selected in S4 (S5).

For example, the route calculation unit 134 calculates a route having the largest surplus bandwidth as a detour route without passing through the detour target link between SLGs storing the target slice based on NW topology information and information on the bandwidth usage of each link (refer to FIG. 4).

After S5, the route calculation unit 134 calculates the minimum surplus bandwidth of the detour route calculated in S4 and the delay amount (delay time) of the detour route (S6).

For example, the route calculation unit 134 calculates a delay amount (delay time) of the minimum surplus bandwidth of the detour route and the detour route calculated in S4 based on the physical bandwidth, the bandwidth usage, and the transfer delay amount (refer to FIG. 4) of each link.

After S6, the selection unit 133 determines whether the bandwidth usage of the target slice is equal to or less than the minimum surplus bandwidth of the detour route calculated in S6, and the target slice has no delay tolerance (delay requirement), or it is equal to or greater than the delay amount of the detour route calculated in S6 (S7).

Here, in a case where the selection unit 133 determines that the bandwidth usage of the target slice is equal to or less than the minimum surplus bandwidth of the detour route calculated in S6 and that the target slice has no delay tolerance or it is equal to or greater than the delay amount of the detour route calculated in S6 (Yes in S7), the processing proceeds to S8.

The path setting unit 140 sets the inter-SLG path via the detour route calculated in S5, and changes distribution setting in the SLG 20 so that traffic of the target slice passes the inter-SLG path (S8).

On the other hand, in a case where the selection unit 133 determines that the bandwidth usage of the target slice exceeds the minimum surplus bandwidth of the detour route calculated in S6, and in a case where it is determined that the delay tolerance of the target slice is present or that the delay tolerance of the detour route calculated in S6 is less than the delay tolerance of the detour route (No in S7), the processing proceeds to S14. Then, the selection unit 133 excludes the target slice from the candidate slice group specified in S2 (S14), and the processing returns to S3.

After S8, the detour route calculation unit 130 determines that the bandwidth usage rate of the detour target link detected in S1 is equal to or less than a threshold (Yes in S9) and in a case where one or more slices are detouring (Yes in S10), the bandwidth usage of the detour target link and the bandwidth usage of the slice detouring the route are measured at predetermined time intervals without performing of detouring the remaining candidate slice groups (S11).

Then, in a case where the elimination determining unit 135 determines that the sum of the bandwidths measured in S11 is equal to or less than the threshold of the bandwidth of the detour target link (Yes in S12), the processing proceeds to S13. For example, in a case where the elimination determining unit 135 determines that the value of the sum of bandwidths measured in S11/the physical bandwidth of the detour target link is equal to or less than a predetermined threshold, the processing proceeds to S13. Then, the path setting unit 140 changes the inter-SLG path of the storage destination of the slice detouring the route to that before the route detouring, and eliminates the inter-SLG path for detouring (S13).

In a case where the detour route calculation unit 130 determines that the bandwidth usage rate of the detour target link detected in S1 exceeds a threshold (No in S9), the processing proceeds to S14. In addition, the detour route calculation unit 130 does not detour the slice (No in S10), the processing is finished.

In this way, the NW controller 100 can detour the route of the slice and eliminate the route detouring.

### Specific Example of Processing Procedure

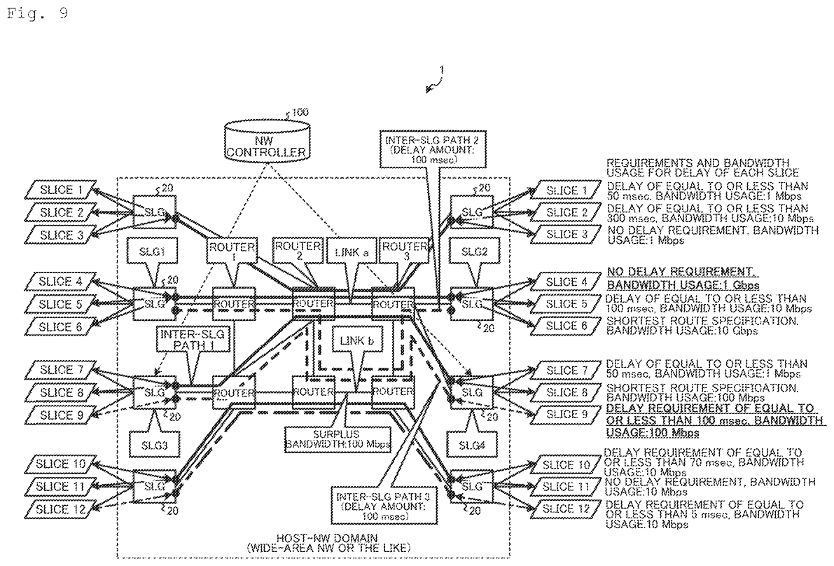

Next, a specific example of the processing procedure of the NW controller 100 will be described with reference to FIG. 9. Here, a case where the network to be controlled by the NW controller 100 is the network illustrated in FIG. 9 will be described as an example. The requirements for delay of each slice and the bandwidth usage are as illustrated in FIG. 9.

Here, since the bandwidth pressure occurs in the link a illustrated in FIG. 9, the NW controller 100 will be described with reference to an example of the case where the route detouring is performed for any of the slices passing through the link a.

(1) The NW information collection unit 110 of the NW controller 100 collects information on a bandwidth usage and a transfer delay amount of each link between the SLG 20 and the transfer device 30 in a host NW domain at a predetermined period, and stores the collected information in the DB unit 120.

(2) The detour route calculation unit 130 determines whether there is a link whose the bandwidth use rate is equal to or greater than a predetermined threshold from the physical bandwidth and the bandwidth usage (see FIG. 4) of each link of the DB unit 120 at a predetermined period. Hereinafter, a case in which the use rate of the bandwidth of the link a illustrated in FIG. 8 becomes equal to or greater than a predetermined threshold will be described.

(3) The detour route calculation unit 130 specifies a candidate slice group from slices stored in the inter-SLG path via the link a based on the information of the DB unit 120. For example, the detour route calculation unit 130 specifies slices 1, 2, 3, 4, 5, 7, and 9 having no shortest route designation as a candidate slice group from slices stored in the inter-SLG path via the link a.

(4) Since one or more slices are included in the candidate slice group, the detour route calculation unit 130 selects the slice 4 which is the slice having the largest bandwidth usage from the candidate slice group.

(5) The detour route calculation unit 130 calculates a route having the largest surplus bandwidth without passing through the link a in the route between the SLG 1 and the SLG 2 in which the slice 4 is stored. For example, the detour route calculation unit 130 calculates a route of the inter-SLG path 2.

(6) The detour route calculation unit 130 calculates the minimum surplus bandwidth and the delay amount of the route of the inter-SLG path 2 based on the bandwidth usage, physical bandwidth, and transfer delay amount of each link held by the DB unit 120 (see FIG. 4). Here, it is assumed that the minimum surplus bandwidth of the route of the inter-SLG path is 100 Mbsp and the delay amount is 100 msec.

(7) The bandwidth usage (1 Gpbs) of the slice 4 exceeds the minimum surplus bandwidth (100 mbsp) of the route of the inter-SLG path 2. Therefore, the detour route calculation unit 130 excludes the slice 4 from the candidate slice group.

(8) The detour route calculation unit 130 selects the slice 9 which is a slice having the largest bandwidth usage from the remaining candidate slice groups. It is assumed that the slice 9 is stored in the inter-SLG path 1 set between the SLG 3 and the SLG 4.

(9) Similarly to the case of the slice 4, the detour route calculation unit 130 calculates a route having the largest surplus bandwidth without passing through the link a in the route between SLG3 and SLG4 in which the slice 9 is stored. For example, the detour route calculation unit 130 calculates a route of the inter-SLG path 3. In addition, the detour route calculation unit 130 calculates the minimum surplus bandwidth and the delay amount of the route of the inter-SLG path 3. Here, it is assumed that the minimum surplus bandwidth of the route of the inter-SLG path 3 is 100 Mbps and the delay amount is 100 msec.

(10) In this case, since the bandwidth usage of the slice 9 is equal to or less than the minimum excess bandwidth of the route and also satisfies delay requirements, the detour route calculation unit 130 determines that the slice 9 is a target slice.

(11) The path setting unit 140 of the NW controller 100 sets the inter-SLG path 3 in the path control unit 22 of the SLG3 and SLG4 based on the determination result of the detour route calculation unit 130. In addition, the path setting unit 140 sets the output destination selection unit 21 of the SLG3 and SLG4 to select the inter-SLG path 3 as the output destination of the slice 9. According to the above setting, the traffic of the slice 9 passes through the inter-SLG path 3.

(12) When the bandwidth use rate of the link a becomes equal to or less than a predetermined threshold due to the route detour of the traffic of the slice 9, the detour route calculation unit 130 does not detour the remaining candidate slice group, the bandwidth usages of the link a and the slice 9 are acquired from the DB unit 120 at predetermined time intervals.

(13) The detour route calculation unit 130 calculates a ratio of a sum of bandwidth usages of the link a and the slice 9 to a physical bandwidth of the link a, and in a case where the ratio is determined to be equal to or less than a predetermined threshold, the path setting unit 140 of the NW controller eliminates the route detour of the slice 9 in the following manner based on the result of the determination.

(14) For example, the path setting unit 140 sets the output destination selection unit 21 of the SLG 3 and SLG 4 to select the inter-SLG path 1 (the inter-SLG path in which the slice 9 is stored before detouring the route) as the output destination of the slice 9 based on the determination result. In addition, the path setting unit 140 eliminates the setting of the inter-SLG path 3 from the path control units 22 of the SLG 3 and SLG4.

Thus, the NW controller 100 can return the slice to the original route after the pressure of the bandwidth of the link is eliminated by the route detour of the slice.

The NW controller 100 described above may be applied not only a in a case where the pressure on the bandwidth of the link occurs, but also in a case where the result of traffic prediction indicates that the bandwidth will be under bandwidth pressure or in a case where the bandwidth of a specific link is reduced due to maintenance work or the like, and may also be applied to route detours (for example, in a case of forming LAG, maintenance work for some of the member links in a LAG).

The components of the units illustrated in the figures are functional concepts, and do not necessarily need to be physically configured in the same way as illustrated in the figures. That is, a specific form of distribution and integration of individual devices is not limited to the illustrated form, and all or a part of the configuration can be functionally or physically distributed and integrated in any unit according to various loads, usage conditions, and the like. Furthermore, all or any part of each processing function performed in each device can be realized by a CPU and a program executed by the CPU, or can be realized as hardware by a wired logic.

Also, out of the processing described in the present embodiment, all or part of processing described as being automatically performed can be manually performed, alternatively, all or part of processing described as being manually performed can be automatically performed by known methods. In addition, the processing procedure, the control procedure, specific names, information including various types of data and parameters that are illustrated in the above document and drawings may be arbitrarily changed unless otherwise described.

### [Program]

The NW controller 100 described can be implemented by installing the program in a desired computer as package software or on-line software. For example, by causing the information processing device to execute the above program, the information processing device can be made to function as the NW controller 100 of each embodiment. The information processing device which is described here includes a desktop type or notebook type personal computer. In addition, the information processing device includes a mobile communication terminal such as a smart phone, a mobile phone, and a personal handyphone system (PHS), a terminal such as personal digital assistant (PDA), or the like in its category.

In addition, the NW controller 100 may be implemented as a server device which provides a service related to the processing to a client which is a terminal device used by a user as a client. In this case, the server device may be implemented as a Web server, or may be implemented as a cloud that provides services related to the above processing through outsourcing.

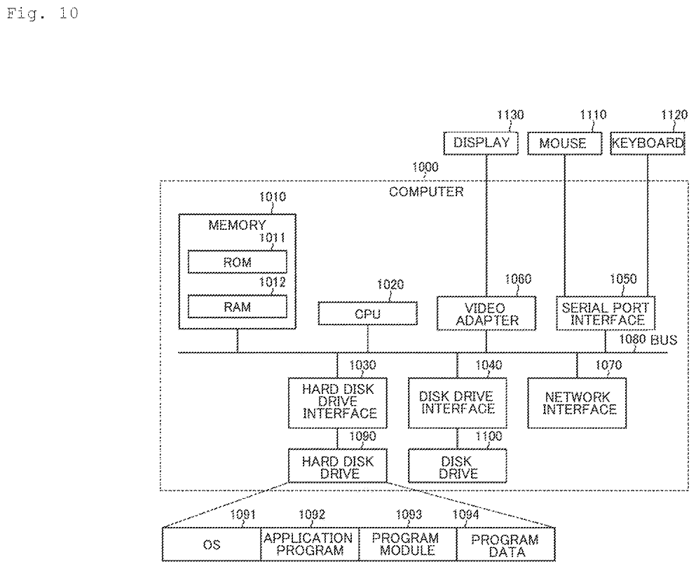

FIG. 10 is a diagram illustrating an example of a computer that executes a network control program. A computer 1000 includes, for example, a memory 1010 and a CPU 1020. In addition, the computer 1000 also includes a hard disk drive interface 1030, a disk drive interface 1040, a serial port interface 1050, a video adapter 1060, and a network interface 1070. Each of these units is connected by a bus 1080.

The memory 1010 includes a read only memory (ROM) 1011 and a random access memory (RAM) 1012. The ROM 1011 stores, for example, a boot program, such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, the program defining each kind of processing executed by the NW controller 100 is implemented as the program module 1093 in which a code executable by the computer is described. The program module 1093 is stored in, e.g., the hard disk drive 1090. For example, the program module 1093 for executing processing similar to the functional configuration of the NW controller 100 is stored in the hard disk drive 1090. Note that the hard disk drive 1090 may also be replaced by a SSD.

In addition, the data used in the processing in the above embodiment is stored in, for example, the memory 1010 or hard disk drive 1090 as the program data 1094. Then, the CPU 1020 reads the program module 1093 or program data 1094 stored in the memory 1010 or hard disk drive 1090 into the RAM 1012 and performs it as necessary.

The program module 1093 and program data 1094 are not limited to being stored in the hard disk drive 1090, and may also be stored in, for example, a removable storage medium and read out by the CPU 1020 via the disk drive 1100. Alternatively, the program module 1093 and program data 1094 may be stored in other computers connected via a network (for example, local area network (LAN) or wide area network (WAN)). Then, the program module 1093 and program data 1094 may be read out from the other computers via the network interface 1070 by the CPU 1020.

### REFERENCE SIGNS LIST

1 System
20 SLG
21 Output destination selection unit
22 Path control unit
30 Transfer device
100 NW controller
110 NW information collection unit
120 DB unit
130 Detour route calculation unit
131 Detection unit
132 Candidate slice specification unit (specification unit)
133 Selection unit
134 Route calculation unit
135 Elimination determining unit (determination unit)
140 Path setting unit

1. A network controller comprising at least one processor configured to perform operations comprising:
specifying a slice capable of changing a route among slices stored in a path between slice gateways (SLGs) via a link to be detoured based on network requirements set for each slice;
calculating a detour route for detouring the link to be detoured from among routes between the SLGs accommodating the specified slice;
selecting a slice having the largest bandwidth usage from slices whose bandwidth usage of the slice is equal to or less than a surplus bandwidth of a detour route of the slice among the specified slices; and
newly setting an inter-SLG path passing through the detour route, and performing route detour processing for changing the setting of the SLG so that the selected slice passes through the set inter-SLG path.

2. The network controller according to claim 1, wherein the at least one processor is configured to perform operations further comprising:
calculating a route which detours the link to be detoured and has the largest surplus bandwidth as a detour route of the slice from among routes between SLGs storing the specified slice.

3. The network controller according to claim 1, wherein the at least one processor is configured to perform operations further comprising:
selecting a slice having the largest bandwidth usage from slices in which the bandwidth usage of the slice is equal to or less than the surplus bandwidth of the detour route of the slice and a communication delay time on the detour route side of the slice satisfies the delay requirement of the slice, among the specified slices.

4. The network controller according to claim 1, wherein the at least one processor is configured to perform operations further comprising:
determining whether a total value of a bandwidth usage of the selected slice after the route detour processing and a bandwidth usage of the link to be detoured is equal to or less than a bandwidth allocated to the link, and changing,
in a case where a total value of a bandwidth usage after the route detour processing of the selected slice and a bandwidth usage of the link to be detoured becomes equal to or less than a bandwidth allocated to the link, setting of the SLG so that the slice passes through the path between SLGs before the route detour processing, and eliminates the path between SLGs used for the route detour processing.

5. A network control method comprising:
specifying a slice capable of changing a route among slices stored in a path between slice gateways (SLGs) via a link to be detoured based on network requirements set for each slice;
calculating a detour route for detouring the link to be detoured from among routes between the SLGs accommodating the specified slice;
selecting a slice having the largest bandwidth usage from slices whose bandwidth usage of the slice is equal to or less than a surplus bandwidth of a detour route of the slice among the specified slices; and
newly setting an inter-SLG path passing through the detour route, and performing route detour processing for changing the setting of the SLG so that the selected slice passes through the set inter-SLG path.

6. A non-transitory computer readable medium storing instructions that, when executed, cause a computer to perform operations comprising:
specifying a slice capable of changing a route among slices stored in a path between slice gateways (SLGs) via a link to be detoured based on network requirements set for each slice;
calculating a detour route for detouring the link to be detoured from among routes between the SLGs accommodating the specified slice;
selecting a slice having the largest bandwidth usage from slices whose bandwidth usage of the slice is equal to or less than a surplus bandwidth of a detour route of the slice among the specified slices; and
newly setting an inter-SLG path passing through the detour route, and performing route detour processing for changing the setting of the SLG so that the selected slice passes through the set inter-SLG path.
